(19) United States
(12) Patent Application Publication
(10) Pub. No.: US 2022/0145767 A1
(43) Pub. Date: May 12, 2022

(54) ROTATING MACHINE AND SEAL RING

(71) Applicant: Mitsubishi Power, Ltd., Yokohama-shi, Kanagawa (JP)

(72) Inventors: Rimpei Kawashita, Tokyo (JP); Kenichi Murata, Yokohama-shi (JP)

(73) Assignee: Mitsubishi Power, Ltd., Yokohama-shi, Kanagawa (JP)

(21) Appl. No.: 17/433,422

(22) PCT Filed: Jan. 24, 2020
(86) PCT No.: PCT/JP2020/002441

§ 371 Date: Aug. 24, 2021

(30) Foreign Application Priority Data
Mar. 8, 2019 (JP) 2019-043171

(51) Int. Cl. F01D 11/08; F01D 5/26

(52) U.S. Cl. CPC F01D 11/08; F05D 2260/963; F05D 2240/59; F01D 5/26

(57) ABSTRACT

A rotating machine includes a rotor which is configured to rotate about an axis, a stator which faces the rotor in a radial direction, and a plurality of seal fins which are provided so as to be protruded from one of the rotor and the stator toward the other of the rotor and the stator in the radial direction and are arranged with gaps therebetween in an axial direction, and one of the rotor and the stator includes an acoustic space which is formed as a hollow portion inside the one of the rotor and the stator, and a communication hole which allows communication between the acoustic space and a part between adjacent seal fins of the plurality of seal fins, the adjacent seal fins being adjacent to each other in the axial direction.

### TECHNICAL FIELD

The present invention relates to a rotating machine and a seal ring.

Priority is claimed on Japanese Patent Application No. 2019-043171, filed Mar. 8, 2019, the content of which is incorporated herein by reference.

### BACKGROUND ART

A steam turbine converts the energy of a fluid taken in from the outside into a rotary motion of a rotor. Specifically, a steam turbine includes a rotor which rotates about an axis, and a casing which covers the rotor from an outer circumferential side. A plurality of blade stages (blades) are provided on an outer circumferential surface of the rotor, and a plurality of vane stages (vanes) are provided on an inner circumferential surface of the casing. The blade stages and the vane stages are alternately arranged in an axial direction. A fluid guided into the casing alternately collides with the blade stages and the vane stages, thereby rotating the rotor.

In a steam turbine, in order to realize smooth rotation of a rotor, a clearance is generally provided between an outer circumferential surface of the rotor and an inner circumferential surface of a casing. As an example, a uniform clearance is provided between tip portions (shrouds) of blades and the inner circumferential surface of the casing. However, since part of steam passes through the clearance and flows away to a downstream side without colliding with the blades or vanes, it does not contribute to rotation driving of the rotor. Therefore, a technology for reducing flowing (leakage) of steam in this clearance as much as possible is required. As an example of such a technology, a technology disclosed in the following Patent Document 1 is known. In a seal device according to Patent Document 1, a plurality of seal fins are provided on an inner circumferential surface of a casing so as to be extended toward an outer circumferential surface of a rotor.

### CITATION LIST

### Patent Document

Patent Document 1: Japanese Unexamined Patent Application, First Publication No. H7-19005

### SUMMARY OF INVENTION

### Technical Problem

In a steam turbine including such a seal device described above, a deviation occurs in pressure distribution of steam in a circumferential direction of a rotor when the rotor is displaced in a radial direction. Specifically, the pressure rises in a region in which the rotor and a casing are relatively close to each other, and the pressure falls in a region in which the rotor and the casing are separated from each other. Accordingly, an excitation force (seal excitation force) in a direction orthogonal to a displacement direction is applied to the rotor. As a result, there is a possibility that whirling vibration may occur in the rotor.

The present invention is made to solve the above problems, and an object thereof is to provide a rotating machine and a seal ring in which unstable vibration is further reduced.

### Solution to Problem

According to an aspect of the present invention, a rotating machine includes a rotor which is configured to rotate about an axis, a stator which faces the rotor in a radial direction, and a plurality of seal fins which are provided so as to be protruded from one of the rotor and the stator toward the other of the rotor and the stator in the radial direction and are arranged with gaps therebetween in an axial direction, in which one of the rotor and the stator includes an acoustic space which is formed as a hollow portion inside the one of the rotor and the stator, and a communication hole which allows communication between the acoustic space and a part between adjacent seal fins of the plurality of seal fins, the adjacent seal fins being adjacent to each other in the axial direction.

According to the above configuration, the acoustic space and the communication hole are formed in any one of the rotor and the stator. The communication hole allows communication between the acoustic space and a part between the seal fins. That is, the communication hole and the acoustic space form a Helmholtz resonator. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated.

In the rotating machine, the stator may include a seal ring main body which has a tubular shape centering on the axis, the plurality of seal fins may be provided on an inner circumferential surface of the seal ring main body, and the acoustic space may be formed inside the seal ring main body.

According to the above configuration, the acoustic space is formed inside the seal ring main body serving as the stator. That is, the communication hole and the acoustic space form a Helmholtz resonator inside the seal ring main body. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated.

In the rotating machine, a plurality of the acoustic spaces may be formed inside the seal ring main body and arranged with gaps therebetween in a circumferential direction.

According to the above configuration, since the plurality of acoustic spaces are formed with gaps therebetween in the circumferential direction, a pressure fluctuation can be alleviated evenly in the circumferential direction.

In the rotating machine, a volume may differ between a pair of acoustic spaces of the plurality of acoustic spaces adjacent to each other in the circumferential direction.

According to the above configuration, since the volume differs between the pair of acoustic spaces adjacent to each other in the circumferential direction, pressure fluctuations having different vibration frequencies can be alleviated by the acoustic spaces. Therefore, a pressure fluctuation over a wider band can be alleviated.

In the rotating machine, a plurality of the acoustic spaces may be formed inside the seal ring main body and arranged with gaps therebetween in the radial direction.

According to the above configuration, since the plurality of acoustic spaces are formed with gaps therebetween in the radial direction, a pressure fluctuation can be further reduced.

In the rotating machine, a volume may differ between a pair of acoustic spaces of the plurality of acoustic spaces adjacent to each other in the radial direction.

According to the above configuration, since the volume differs between the pair of acoustic spaces adjacent to each other in the radial direction, pressure fluctuations having different vibration frequencies can be alleviated by the acoustic spaces. Therefore, a pressure fluctuation over a wider band can be alleviated.

In the rotating machine, a position in the circumferential direction may differ between one end of the communication hole and the other end of the communication hole when viewed in the axial direction.

According to the above configuration, since the position in the circumferential direction differs between one end and the other end of the communication hole, the length of the communication hole can be secured longer. Thereby, the natural vibration frequency of the Helmholtz resonator formed by the acoustic space and the communication hole can be varied. Accordingly, a pressure fluctuation over a wider band can be alleviated.

In the rotating machine, the communication hole may be formed so as to be extended in a direction inclined with respect to the radial direction when viewed in the axial direction.

According to the above configuration, since the communication hole extends in a direction inclined with respect to the radial direction, the length of the communication hole can be secured longer. Thereby, the natural vibration frequency of the Helmholtz resonator formed by the acoustic space and the communication hole can be varied. Accordingly, a pressure fluctuation over a wider band can be alleviated.

In the rotating machine, the stator may include a stator main body which has a recessed accommodation portion formed on a surface, of the stator main body, which faces the rotor so as to be recessed outward in the radial direction, and a seal ring which has the plurality of seal fins, in which at least a part of the seal ring is accommodated in the recessed accommodation portion, a space in the recessed accommodation portion on a side outward in the radial direction from the seal ring may serve as the acoustic space, and the communication hole may be formed in the seal ring so as to penetrate the seal ring, in which one end of the communication hole communicates with the acoustic space.

According to the above configuration, a space in the recessed accommodation portion on a side outward in the radial direction from the seal ring serves as the acoustic space. The acoustic space communicates with the part between the seal fins through the communication hole penetrating the seal ring. That is, a Helmholtz resonator is formed by the communication hole and the acoustic space. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated.

In the rotating machine, the rotor may include a rotary shaft is formed so as to be extended along the axis, and a plurality of blades which are provided on an outer circumferential surface of the rotary shaft and are arranged in a circumferential direction, the stator may include a casing which covers the rotary shaft and the plurality of blades from an outer circumferential side, the seal fins may be provided on a surface, of the casing, which faces the blade in the radial direction, and the acoustic space may be formed inside the casing.

According to the above configuration, the seal fins are provided directly on the casing, and the acoustic space is formed inside the casing. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated. In addition, according to the above configuration, even in a case in which a rotating machine does not have a seal ring, unstable vibration can be effectively reduced by forming the acoustic space in the casing.

In the rotating machine, the rotor may include a rotary shaft is formed so as to be extended along the axis, and a plurality of blades which are provided on an outer circumferential surface of the rotary shaft and are arranged in a circumferential direction, the stator may include a casing which covers the rotary shaft and the plurality of blades from an outer circumferential side, the seal fins may be provided on a surface, of the casing, which faces the blade in the radial direction, and the acoustic space may be formed in a box body which is provided on an outer circumferential side of the casing.

According to the above configuration, the seal fins are provided directly on the casing, and the box body serving as the acoustic space is provided on the outer circumferential side of the casing. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated. In addition, according to the above configuration, even in a case in which a rotating machine does not have a seal ring, unstable vibration can be effectively reduced by providing the box body serving as the acoustic space on the outer circumferential side of the casing.

According to another aspect of the present invention, a seal ring includes a seal ring main body which has a tubular shape centering on an axis, a plurality of seal fins which are provided on an inner circumferential surface of the seal ring main body so as to be protruded inward in a radial direction and are arranged with gaps therebetween in an axial direction, an acoustic space which is formed as a hollow portion inside the seal ring main body, and a communication hole which allows communication between the acoustic space and a part between adjacent seal fins of the plurality of seal fins, the adjacent seal fins being adjacent to each other in the axial direction.

According to the above configuration, the acoustic space and the communication hole are formed inside the seal ring. The communication hole allows communication between the acoustic space and a part between the seal fins. That is, the communication hole and the acoustic space form a Helmholtz resonator. Therefore, when a pressure fluctuation in a working fluid occurs in the part between the seal fins, air inside the acoustic space resonates due to the pressure fluctuation. At this time, an energy of the working fluid is consumed by compression and expansion of the working fluid inside the acoustic space, friction of the working fluid mainly in the communication hole, and the like. As a result, a pressure fluctuation in the working fluid can be alleviated.

In the seal ring, a plurality of the acoustic spaces may be formed inside the seal ring main body and arranged with gaps therebetween in a circumferential direction.

According to the above configuration, since the plurality of acoustic spaces are formed with gaps therebetween in the circumferential direction, a pressure fluctuation can be alleviated evenly in the circumferential direction.

In the seal ring, a volume may differ between a pair of acoustic spaces of the plurality of acoustic spaces adjacent to each other in the circumferential direction.

According to the above configuration, since the volume differs between the pair of acoustic spaces adjacent to each other in the circumferential direction, pressure fluctuations having different vibration frequencies can be alleviated by the acoustic spaces. Therefore, a pressure fluctuation over a wider band can be alleviated.

In the seal ring, a plurality of the acoustic spaces may be formed inside the seal ring main body and arranged with gaps therebetween in the radial direction.

According to the above configuration, since the plurality of acoustic spaces are formed with gaps therebetween in the radial direction, a pressure fluctuation can be further reduced.

In the seal ring, a volume may differ between a pair of acoustic spaces of the plurality of acoustic spaces adjacent to each other in the radial direction.

According to the above configuration, since the volume differs between the pair of acoustic spaces adjacent to each other in the radial direction, pressure fluctuations having different vibration frequencies can be alleviated by the acoustic spaces. Therefore, a pressure fluctuation over a wider band can be alleviated.

In the seal ring, a position in the circumferential direction may differ between one end of the communication hole and the other end of the communication hole when viewed in the axial direction.

According to the above configuration, since the position in the circumferential direction differs between one end and the other end of the communication hole, the length of the communication hole can be secured longer. Thereby, the natural vibration frequency of the Helmholtz resonator formed by the acoustic space and the communication hole can be varied. Accordingly, a pressure fluctuation over a wider band can be alleviated.

In the seal ring, the communication hole may be formed so as to be extended in a direction inclined with respect to the radial direction when viewed in the axial direction.

According to the above configuration, since the communication hole extends in a direction inclined with respect to the radial direction, the length of the communication hole can be secured longer. Thereby, the natural vibration frequency of the Helmholtz resonator formed by the acoustic space and the communication hole can be varied. Accordingly, a pressure fluctuation over a wider band can be alleviated.

### Advantageous Effects of Invention

According to the present invention, it is possible to provide a rotating machine and a seal ring in which unstable vibration is further reduced.

### BRIEF DESCRIPTION OF DRAWINGS

FIG. 1 is a schematic view illustrating a configuration of a steam turbine (rotating machine) according to a first embodiment of the present invention.

FIG. 2 is an enlarged cross-sectional view of a main part of the steam turbine according to the first embodiment of the present invention.

FIG. 3 is a cross-sectional view illustrating a configuration of a seal ring according to the first embodiment of the present invention.

FIG. 4 is a cross-sectional view along line A-A in FIG. 3.

FIG. 5 is a cross-sectional view illustrating a modification example of the seal ring according to the first embodiment of the present invention.

FIG. 6 is a cross-sectional view illustrating a configuration of a seal ring according to a second embodiment of the present invention.

FIG. 7 is a cross-sectional view illustrating a configuration of a seal ring according to a third embodiment of the present invention.

FIG. 8 is a cross-sectional view illustrating a modification example of the seal ring according to the third embodiment of the present invention.

FIG. 9 is a cross-sectional view illustrating a configuration of a seal ring according to a fourth embodiment of the present invention.

FIG. 10 is an enlarged cross-sectional view of a main part of the steam turbine according to a fifth embodiment of the present invention.

FIG. 11 is an enlarged cross-sectional view of a main part of the steam turbine according to a sixth embodiment of the present invention.

FIG. 12 is an enlarged cross-sectional view of a main part illustrating a modification example common to the steam turbine according to each of the embodiments of the present invention.

### DESCRIPTION OF EMBODIMENTS

### First Embodiment

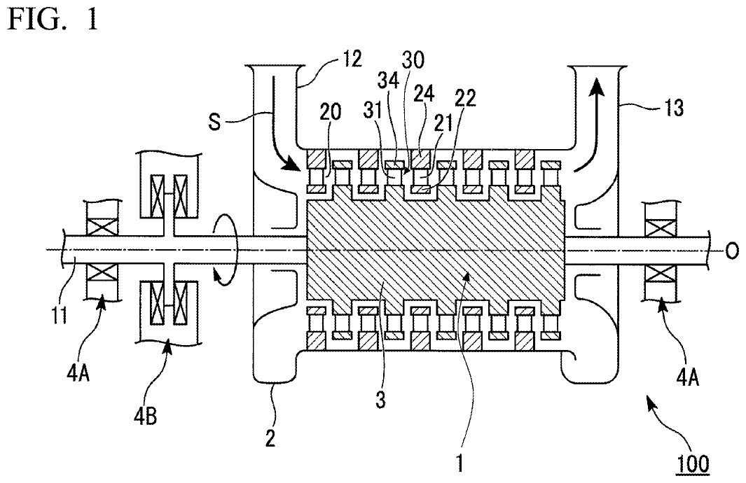

A first embodiment of the present invention will be described with reference to FIGS. 1 to 4. A steam turbine 100 according to the present embodiment includes a steam turbine rotor 3 (rotor) which extends in an axis O direction, a steam turbine casing 2 (stator) which covers the steam turbine rotor 3 from an outer circumferential side, and a journal bearing 4A and a thrust bearing 4B which support a shaft end 11 of the steam turbine rotor 3 so as to be rotatable about an axis O.

The steam turbine rotor 3 has a rotary shaft 1 which extends in the axis O, and a plurality of blades 30 which are provided on an outer circumferential surface of the rotary shaft 1. A plurality of blades 30 are arranged with uniform gaps therebetween in a circumferential direction of the rotary shaft 1. A plurality of rows of the blades 30 are arranged with uniform gaps therebetween in the axis O direction. Each of the blades 30 has a blade main body 31 and a blade shroud 34. The blade main body 31 protrudes outward in a radial direction from an outer circumferential surface of the steam turbine rotor 3. The blade main body 31 has a cross section having a blade profile when viewed in the radial direction. The blade shroud 34 is provided at a tip portion (an end portion on a side outward in the radial direction) of the blade main body 31.

The steam turbine casing 2 has substantially a tubular shape covering the steam turbine rotor 3 from the outer circumferential side. A steam supply pipe 12 for taking in steam S is provided on one side of the steam turbine casing 2 in the axis O direction. A steam discharge pipe 13 for discharging the steam S is provided on the other side of the steam turbine casing 2 in the axis O direction. Steam flows from one side toward the other side in the axis O direction inside the steam turbine casing 2. In the following description, a direction in which steam flows will be simply referred to as “a flowing direction”. Moreover, a side where the steam supply pipe 12 is positioned when viewed from the steam discharge pipe 13 will be referred to as an upstream side in the flowing direction, and a side where the steam discharge pipe 13 is positioned when viewed from the steam supply pipe 12 will be referred to as a downstream side in the flowing direction.

A plurality of rows of vanes 20 are provided on an inner circumferential surface of the steam turbine casing 2. Each of the vanes 20 has a vane main body 21, a vane shroud 22, and a vane pedestal 24. The vane main body 21 is a member having a vane shape and connected to the inner circumferential surface of the steam turbine casing 2 with the vane pedestal 24 therebetween. Moreover, the vane shroud 22 is provided at a tip portion (an end portion on a side inward in the radial direction) of the vane main body 21. Similar to the blades 30, a plurality of vanes 20 are arranged in the circumferential direction and the axis O direction on the inner circumferential surface. The blades 30 are disposed so as to enter regions between the vanes 20 adjacent to each other. Namely, the vanes 20 and the blades 30 extend in a direction (the radial direction with respect to the axis O) intersecting the flowing direction of steam.

The steam S is supplied to the inside of the steam turbine casing 2 via the steam supply pipe 12 on the upstream side. The steam S alternately collides with the vanes 20 and the blades 30 while passing through the inside of the steam turbine casing 2. The vanes 20 rectify a flow of the steam S, and the blades 30 apply a torque to the steam turbine rotor 3 by the rectified steam S colliding with the blades 30. A torque of the steam turbine rotor 3 is drawn out from the shaft end 11 and is used for driving external equipment (a generator or the like). In accordance with rotation of the steam turbine rotor 3, the steam S is discharged toward a subsequent device (a steam condenser or the like) through the steam discharge pipe 13 on the downstream side.

The journal bearing 4A supports a load in the radial direction with respect to the axis O. One journal bearing 4A is provided at each of both ends of the steam turbine rotor 3. The thrust bearing 4B supports a load in the axis O direction. The thrust bearing 4B is provided at only the end portion of the steam turbine rotor 3 on the upstream side.

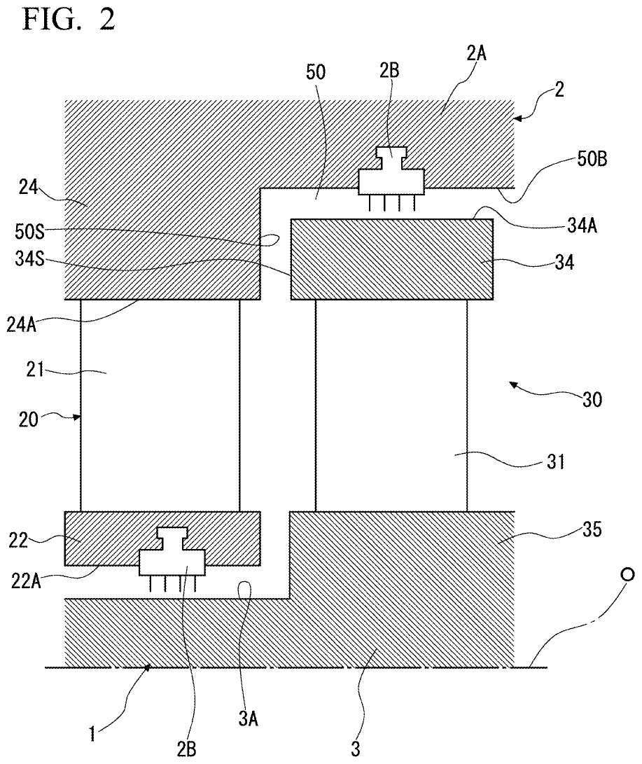

Next, with reference to FIG. 2, a part around the vane 20 and the blade 30 will be described in detail. As illustrated in FIG. 2, the steam turbine casing 2 has a tubular casing main body 2A (stator main body) centering on the axis O, and a seal ring 2B. A cavity 50 recessed outward in the radial direction is formed on an inner circumferential surface of the casing main body 2A. The blade shroud 34 is accommodated inside the cavity 50.

A clearance is formed between a cavity bottom surface 50B that is a surface of the cavity 50 on a side outward in the radial direction and a shroud facing surface 34A that is a surface of the blade shroud 34 on a side outward in the radial direction. The seal ring 2B (which will be described later) is provided in this clearance. More specifically, the seal ring 2B is fixed to the cavity bottom surface 50B. In addition, a clearance is formed between a shroud upstream surface 34S that is a surface of the blade shroud 34 facing the upstream side and a cavity upstream surface 50S that is a surface of the cavity 50 on the upstream side. On a side of the blade main body 31 inward in the radial direction, a platform 35 supporting the blade main body 31 is provided integrally with the rotary shaft 1.

A part of the casing main body 2A at a position corresponding to the vane 20 in the axis O direction serves as the vane pedestal 24. The end portion of the vane main body 21 on a side outward in the radial direction is fixed to a pedestal inner circumferential surface 24A that is a surface of the vane pedestal 24 facing a side inward in the radial direction. The vane shroud 22 is provided at the end portion of the vane main body 21 on a side inward in the radial direction. A vane shroud inner circumferential surface 22A that is a surface of the vane shroud 22 facing a side inward in the radial direction faces a rotor facing surface 3A that is the outer circumferential surface of the rotary shaft 1 with a clearance therebetween. The seal ring 2B (which will be described later) is provided in this clearance. More specifically, the seal ring 2B is provided on the vane shroud inner circumferential surface 22A.

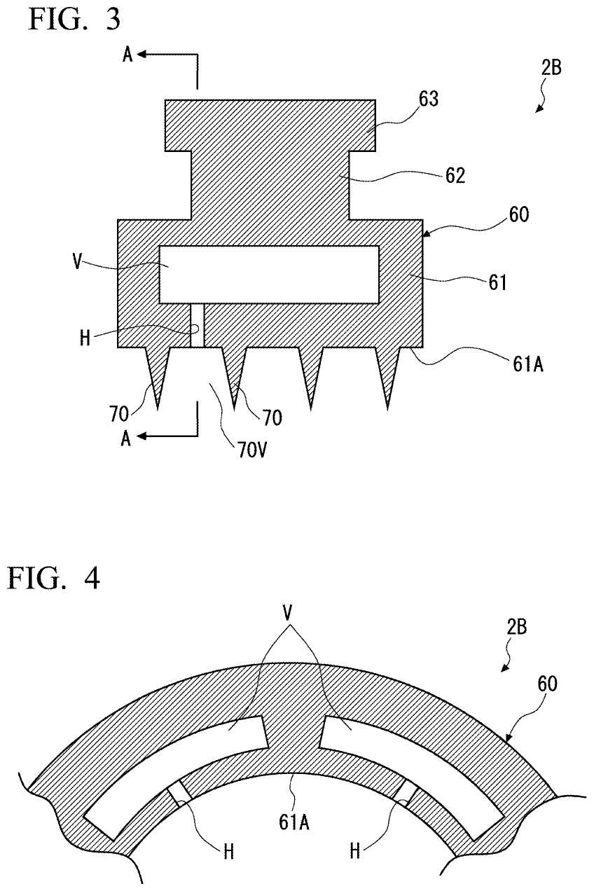

Next, with reference to FIGS. 3 and 4, a configuration of the seal ring 2B will be described. As described above, in the steam turbine 100 according to the present embodiment, the seal ring 2B is provided on each of the cavity bottom surface 50B and the vane shroud inner circumferential surface 22A. The seal rings 2B have the same configuration. As illustrated in FIG. 3, the seal ring 2B has a seal ring main body 60 which has an annular shape centering on the axis O, and a plurality of seal fins 70 which are provided on an inner circumferential side of the seal ring main body 60.

The seal ring main body 60 has a ring portion 61 which has an annular shape centering on the axis O, a reduced portion 62 which is provided on a side of the ring portion 61 outward in the radial direction, and a fitting portion 63 which is provided on a side of the reduced portion 62 farther outward in the radial direction. The ring portion 61 has a rectangular cross-sectional shape when viewed in the circumferential direction, and a hollow portion serving as an acoustic space V is formed inside the ring portion 61. As illustrated in FIG. 4, when viewed in the axis O direction, the acoustic space V is curved in the circumferential direction with respect to the axis O. Moreover, in the present embodiment, inside the ring portion 61, a plurality of acoustic spaces V and a plurality of communication holes H corresponding thereto are formed with gaps therebetween in the circumferential direction. In the present embodiment, volumes of a pair of acoustic spaces V adjacent to each other in the circumferential direction are the same as each other.

The plurality of seal fins 70 are arranged on an inner circumferential surface (ring portion inner circumferential surface 61A) of the ring portion 61 with gaps therebetween in the axis O direction. Each of the seal fins 70 extends inward in the radial direction from the ring portion inner circumferential surface 61A. The dimension of each of the seal fins 70 in the axis O direction gradually decreases as it goes outward in the radial direction. Namely, each of the seal fins 70 has a cross-sectional shape tapered inward in the radial direction.

The acoustic space V and a part (seal space 70V) between the pair of seal fins communicate with each other through the communication hole H. The communication hole H extends in the radial direction from an inner surface of the acoustic space V on a side inward in the radial direction toward the seal space 70V. When viewed in the radial direction, the flow channel cross-sectional area of the communication hole H is smaller than the cross-sectional area of the acoustic space V. In other words, the flow channel cross-sectional area suddenly increases as it goes toward the acoustic space V via the communication hole H. That is, a Helmholtz resonator is formed inside the seal ring main body 60 by the communication hole H and the acoustic space V.

The reduced portion 62 has a dimension in the axis O direction smaller than that of the ring portion 61. The fitting portion 63 has a dimension in the axis O direction larger than that of the ring portion 61. The fitting portion 63 is fitted into a groove formed on each of the cavity bottom surface 50B and the vane shroud inner circumferential surface 22A. Accordingly, the seal rings 2B are respectively fixed to and supported on the cavity bottom surface 50B and the vane shroud inner circumferential surface 22A.

Next, operation of the steam turbine 100 according to the present embodiment will be described. When the steam turbine 100 is driven, first, high-temperature and high-pressure steam is supplied to the inside of the steam turbine casing 2 from an external steam supply source (a boiler or the like) through the steam supply pipe 12. The steam alternately collides with the vanes 20 and the blades 30 inside the steam turbine casing 2. The vanes 20 rectify a flow of the steam such that the steam is directed to the blades 30. The blades 30 obtain a torque by the flow of the rectified steam, thereby applying a torque to the steam turbine rotor 3.

Here, part of steam is not directed to the vanes 20 and the blades 30, and flows into the cavity 50 or a space between the vane shroud inner circumferential surface 22A and the rotor facing surface 3A as a sidestream. For the purpose of reducing the sidestream, the seal rings 2B are provided in these spaces. Specifically, since the sidestream is blocked by the plurality of seal fins 70, a flow directed to the vanes 20 and the blades 30 as a mainstream increases, and thus efficiency of the steam turbine 100 can be improved.

Here, in a case in which the seal rings 2B are provided, a deviation occurs in pressure distribution of steam in the circumferential direction when the steam turbine rotor 3 is displaced in the radial direction. Specifically, the pressure rises in a region in which the steam turbine rotor 3 and the steam turbine casing 2 are relatively close to each other, and the pressure falls in a region in which they are separated from each other. Accordingly, an excitation force (seal excitation force) in a direction orthogonal to a displacement direction is applied to the rotor. As a result, there is a possibility that whirling vibration may occur in the steam turbine rotor 3. In the present embodiment, the acoustic space V and the communication hole H are formed inside the seal ring 2B. The communication hole H and the acoustic space V form a Helmholtz resonator. Therefore, when a pressure fluctuation in steam occurs in the part (seal space 70V) between the seal fins 70, air inside the acoustic space V resonates due to the pressure fluctuation. At this time, an energy of steam is consumed by compression and expansion of the steam inside the acoustic space V, friction of the steam mainly in the communication hole H, and the like. As a result, a pressure fluctuation in steam can be alleviated. Accordingly, unstable vibration due to the seal excitation force can be reduced.

Moreover, according to the above configuration, since the plurality of acoustic spaces V are formed inside the seal ring 2B and are arranged with gaps therebetween in the circumferential direction, a pressure fluctuation can be alleviated evenly in the circumferential direction. Accordingly, unstable vibration can be further reduced.

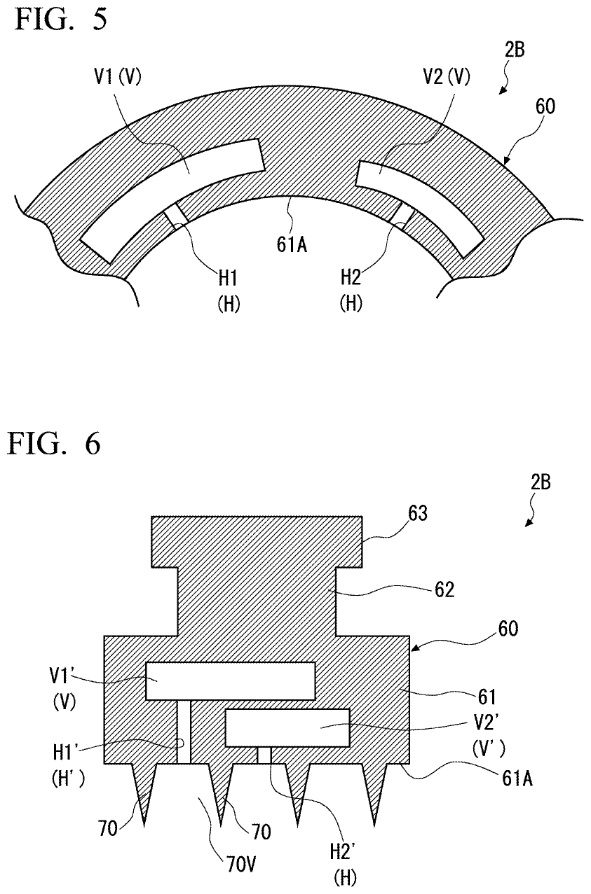

Hereinabove, the first embodiment of the present invention has been described. It is possible to make various changes and modifications to the above configuration without departing from the spirit of the present invention. For example, in the first embodiment, an example in which volumes of the pair of acoustic spaces V adjacent to each other in the circumferential direction are the same as each other has been described. However, the configurations of the acoustic spaces V are not limited to those described above, and the configurations illustrated in FIG. 5 can also be employed as another example. In the example of FIG. 5, the volume differs between a pair of acoustic spaces V adjacent to each other in the circumferential direction. More specifically, the volume of the acoustic space V (first acoustic space V1) on one side in the circumferential direction is larger than the volume of the acoustic space V (second acoustic space V2) on the other side in the circumferential direction. According to this configuration, pressure fluctuations having different vibration frequencies can be alleviated by the acoustic spaces V. Namely, a pressure fluctuation over a wider band can be alleviated.

### Second Embodiment

Subsequently, a second embodiment of the present invention will be described with reference to FIG. 6. The same reference signs are applied to configurations similar to those in the first embodiment, and detailed description will be omitted. As illustrated in FIG. 6, in the seal ring 2B according to the present embodiment, a plurality of acoustic spaces V′ (a first acoustic space V1′ and a second acoustic space V2′) adjacent to each other in the radial direction are formed inside the ring portion 61. The first acoustic space V1′ is positioned on a side outward in the radial direction from the second acoustic space V2′. In addition, the volume of the first acoustic space V1′ is larger than the volume of the second acoustic space V2′. A communication hole H′ (first communication hole H1′) which communicates with the first acoustic space V1′ and another communication hole H′ (second communication hole H2′) which communicates with the second acoustic space V2′ open at different positions. Specifically, the first communication hole H1′ opens on one side (upstream side) in the axis O direction from the second communication hole H2′.

According to the above configuration, since the plurality of acoustic spaces V′ are formed with gaps therebetween in the radial direction, a pressure fluctuation can be further reduced. Moreover, according to the above configuration, since the volume differs between the pair of acoustic spaces V′ adjacent to each other in the radial direction, pressure fluctuations having different vibration frequencies can be alleviated by the acoustic spaces V′. Namely, a pressure fluctuation over a wider band can be alleviated.

Hereinabove, the second embodiment of the present invention has been described. It is possible to make various changes and modifications to the above configuration without departing from the spirit of the present invention.

### Third Embodiment

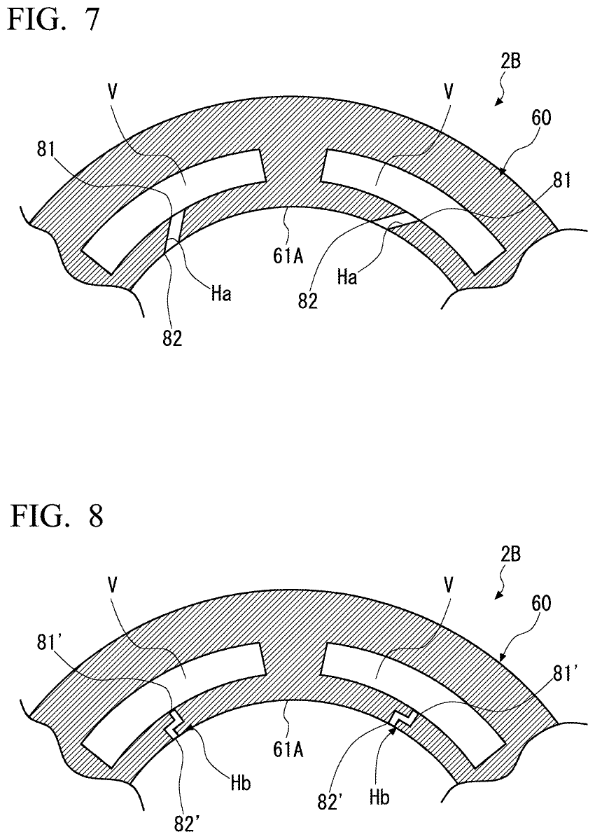

Next, a third embodiment of the present invention will be described with reference to FIG. 7. The same reference signs are applied to configurations similar to those in each of the above embodiments, and detailed description will be omitted. As illustrated in FIG. 7, in the present embodiment, the position in the circumferential direction differs between one end (outer circumferential side opening portion 81) and the other end (inner circumferential side opening portion 82) of a communication hole Ha. Accordingly, when viewed in the axis O direction, the communication hole Ha extends in a direction inclined with respect to the radial direction.

According to the above configuration, compared to a case in which the communication hole Ha extends in the radial direction, the length of the communication hole Ha can be secured longer. Thereby, the natural vibration frequency of the Helmholtz resonator formed by the acoustic space V and the communication hole Ha can be freely varied. Specifically, a Helmholtz resonator corresponding to a desired vibration frequency can be formed by varying the difference in the position in the circumferential direction between one end and the other end of the communication hole Ha (i.e., by varying the inclination angle of the communication hole Ha with respect to the radial direction). Accordingly, a pressure fluctuation over a wider band can be alleviated.

Hereinabove, the third embodiment of the present invention has been described. It is possible to make various changes and modifications to the above configuration without departing from the spirit of the present invention. For example, the configurations illustrated in FIG. 8 can also be employed as another example. In the example of FIG. 8, the position in the circumferential direction differs between an outer circumferential side opening portion 81′ and an inner circumferential side opening portion 82′ of a communication hole Hb, and the communication hole Hb is bent in the radial direction and the circumferential direction. With this configuration, similar to the third embodiment, the length of the communication hole Hb can be secured longer.

### Fourth Embodiment

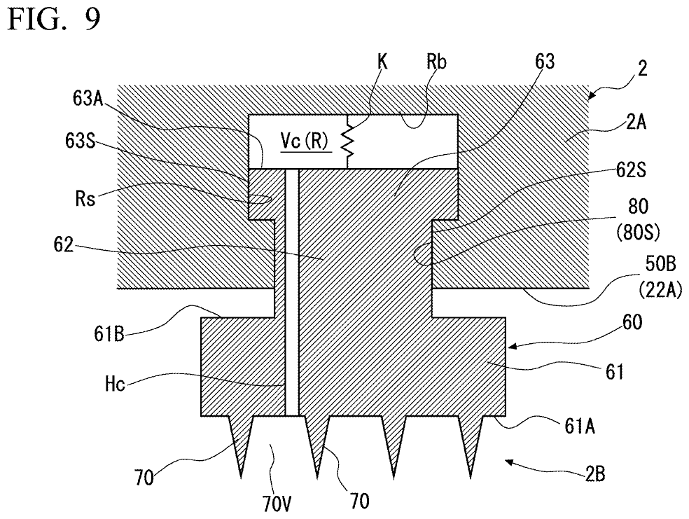

Next, a fourth embodiment of the present invention will be described with reference to FIG. 9. The same reference signs are applied to configurations similar to those in each of the above embodiments, and detailed description will be omitted. As illustrated in FIG. 9, in the present embodiment, a recessed accommodation portion R for accommodating the seal ring 2B is formed on the inner circumferential surface of the casing main body 2A. The recessed accommodation portion R has a rectangular cross-sectional shape in a cross-sectional view including the axis O. The fitting portion 63 of the seal ring main body 60 is fitted into the recessed accommodation portion R. Accordingly, a pair of surfaces (recessed portion side surfaces Rs) of the recessed accommodation portion R directed in the axis O direction are in a state of abutting a pair of surfaces (fitting portion side surfaces 63S) of the fitting portion 63 directed in the axis O direction in a slidable manner.

Moreover, the recessed accommodation portion R is communicated with the cavity bottom surface 50B (or the vane shroud inner circumferential surface 22A) via a neck portion 80. The reduced portion 62 of the seal ring main body 60 is fitted into the neck portion 80. Accordingly, a pair of surfaces (neck portion side surfaces 80S) of the neck portion 80 directed in the axis O direction are in a state of abutting a pair of surfaces (reduced portion side surfaces 62S) of the reduced portion 62 directed in the axis O direction in a slidable manner.

Inside the recessed accommodation portion R, a space serving as an acoustic space Vc is formed between an outer circumferential surface (fitting portion outer circumferential surface 63A) of the fitting portion 63 and a surface (recessed portion bottom surface Rb) of the recessed accommodation portion R on the outer circumferential side. An elastic member K which connects the fitting portion outer circumferential surface 63A and the recessed portion bottom surface Rb to each other is provided inside the acoustic space Vc. The elastic member K biases the seal ring 2B inward in the radial direction. Specifically, a plate spring may be used as the elastic member K. The seal ring 2B can be displaced in the radial direction due to an elastic force of the elastic member K. In addition, in accordance with this displacement, a gap between a surface (ring portion outer circumferential surface 61B) of the ring portion 61 on the outer circumferential side and the cavity bottom surface 50B (or the vane shroud inner circumferential surface 22A) varies.

A communication hole Hc penetrating the seal ring 2B in the radial direction is formed in the seal ring 2B. The communication hole Hc allows communication between the acoustic space Vc and a space between the seal fins 70. More specifically, one end of the communication hole Hc opens on the fitting portion outer circumferential surface 63A, and the other end of the communication hole Hc opens on the ring portion inner circumferential surface 61A.

According to the above configuration, a space in the recessed accommodation portion R on a side outward in the radial direction from the seal ring 2B serves as the acoustic space Vc. This acoustic space Vc communicates with the part between the seal fins 70 through the communication hole Hc penetrating the seal ring 2B. That is, a Helmholtz resonator is formed by the communication hole Hc and the acoustic space Vc. Therefore, when a pressure fluctuation in steam occurs in the part (seal space 70V) between the seal fins 70, air inside the acoustic space Vc resonates due to the pressure fluctuation. At this time, an energy of steam is consumed due to compression and expansion of the steam inside the acoustic space Vc, friction of the steam mainly in the communication holes Hc, and the like. As a result, a pressure fluctuation in steam can be alleviated. As a result, unstable vibration can be reduced.

Hereinabove, the fourth embodiment of the present invention has been described. It is possible to make various changes and modifications to the above configuration without departing from the spirit of the present invention.

### Fifth Embodiment

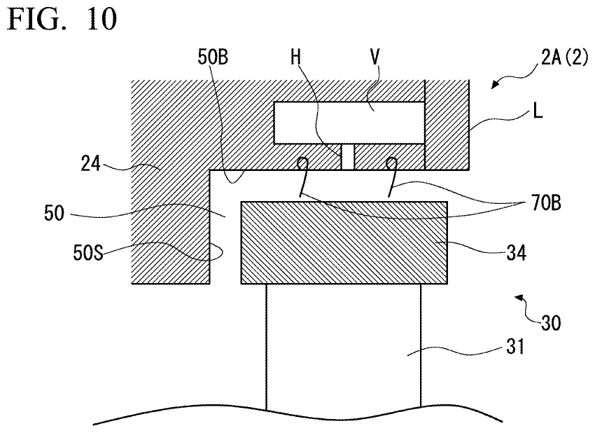

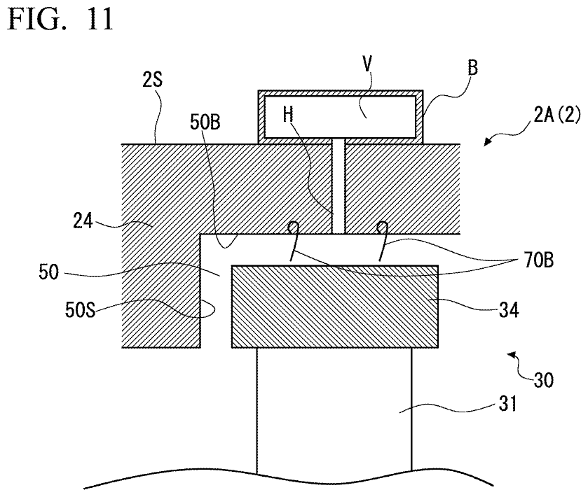

Subsequently, a fifth embodiment of the present invention will be described with reference to FIG. 10. The same reference signs are applied to configurations similar to those in each of the above embodiments, and detailed description will be omitted. As illustrated in FIG. 10, in the present embodiment, a seal fin 70B is directly attached to the casing main body 2A. Specifically, a plurality of (two) seal fins 70B are attached to the cavity bottom surface 50B of the cavity 50 so as to be protruded from the cavity bottom surface 50B toward the blade shroud 34.

Moreover, a hollow portion serving as the acoustic space V is formed inside the casing main body 2A. The acoustic space V is sealed from the other side in the axis O direction using a lid body L that is a part of the steam turbine casing 2. In addition, the acoustic space V communicates with the part (seal space 70V) between the seal fins 70B through the communication hole H.

According to the above configuration, the seal fins 70B are provided directly on the casing main body 2A, and the acoustic space V is formed inside the casing main body 2A. Therefore, when a pressure fluctuation in steam occurs in the part between the seal fins 70B, air inside the acoustic space V resonates due to the pressure fluctuation. At this time, an energy of steam is consumed by compression and expansion of the steam inside the acoustic space V, friction of the steam mainly in the communication hole, and the like. As a result, a pressure fluctuation in steam can be alleviated. In addition, according to the above configuration, even in a case in which the steam turbine 100 does not have a seal ring 2B, unstable vibration can be effectively reduced by forming the acoustic space V inside the casing main body 2A.

Hereinabove, the fifth embodiment of the present invention has been described. It is possible to make various changes and modifications to the above configuration without departing from the spirit of the present invention.

### Sixth Embodiment

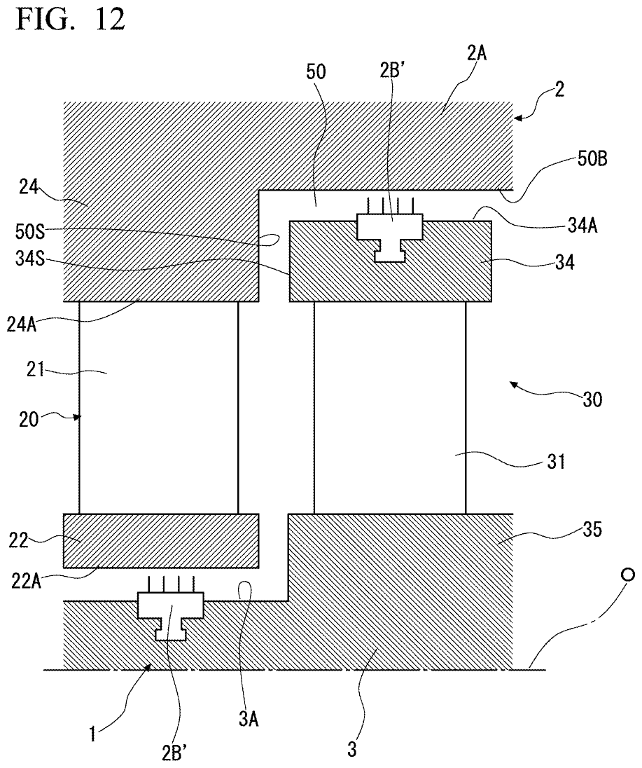

Subsequently, a sixth embodiment of the present invention will be described with reference to FIG. 11. The same reference signs are applied to configurations similar to those in each of the above embodiments, and detailed description will be omitted. As illustrated in FIG. 11, in the present embodiment, a box body B is provided on the outer circumferential surface (casing outer circumferential surface 2S) of the casing main body 2A. A hollow portion serving as the acoustic space V is formed inside the box body B. Moreover, the acoustic space V communicates with the part between (seal space 70V) the seal fins 70B through the communication hole H. The communication hole H penetrates the casing main body 2A in the radial direction.

According to the above configuration, the seal fins 70B are provided directly on the casing main body 2A, and the box body B serving as the acoustic space V is provided on the outer circumferential side of the casing main body 2A. Therefore, when a pressure fluctuation in steam occurs in the part between the seal fins 70B, air inside the acoustic spaces V resonates due to the pressure fluctuation. At this time, an energy of steam is consumed by compression and expansion of the steam inside the acoustic space V, friction of the steam mainly in the communication hole, and the like. As a result, a pressure fluctuation in steam can be alleviated. In addition, according to the above configuration, even in a case in which the steam turbine 100 does not have a seal ring 2B, unstable vibration can be effectively reduced by providing the box body B serving as the acoustic space V on the outer circumferential side of the casing main body 2A.

Hereinabove, the sixth embodiment of the present invention has been described. It is possible to make various changes and modifications to the above configuration without departing from the spirit of the present invention.

### Modification Example Common to Each Embodiment

In each of the above embodiments, an example in which the seal rings 2B or the seal fins 70B are provided on the casing 2 serving as a stator (still body) and the vane shroud 22 has been described. However, as illustrated in FIG. 12, the seal rings 2B or the seal fins 70B may also be provided on the steam turbine rotor 3 serving as a rotor (rotation body) or the blade shroud 34. With this configuration, operations and effects similar to those of each of the above embodiments can be achieved.

### INDUSTRIAL APPLICABILITY

According to the present invention, it is possible to provide a rotating machine and a seal rings in which unstable vibration is further reduced.

### REFERENCE SIGNS LIST

100 Steam turbine
1 Rotary shaft
2 Steam turbine casing
2A Casing main body
2B Seal ring
3 Steam turbine rotor
3A Rotor facing surface
4A Journal bearing
4B Thrust bearing
11 Shaft end
12 Steam supply pipe
13 Steam discharge pipe
20 Vane
21 Vane main body
22 Vane shroud
22A Vane shroud inner circumferential surface
24 Vane pedestal
24A Pedestal inner circumferential surface
30 Blade
31 Blade main body
34 Blade shroud
34A Shroud facing surface
34S Shroud upstream surface
35 Platform
50 Cavity
50B Cavity bottom surface
50S Cavity upstream surface
60 Seal ring main body
61 Ring portion
61A Ring portion inner circumferential surface
61B Ring portion outer circumferential surface
62 Reduced portion
62S Reduced portion side surface
63 Fitting portion
63A Fitting portion outer circumferential surface
63S Fitting portion side surface
70 Seal fin
70V Seal space
80 Neck portion
80S Neck portion side surface
81, 81′ Outer circumferential side opening portion
82, 82′ Inner circumferential side opening portion
B Box body
H, H′, Ha, Hb, Hc Communication hole
H1, H1′ First communication hole
H2, H2′ Second communication hole
K Elastic member
L Lid body
O Axis
R Recessed accommodation portion
Rb Recessed portion bottom surface
Rs Recessed portion side surface
S Steam
V, V′, Vc Acoustic space
V1, V1′ First acoustic space
V2, V2′ Second acoustic space

1. A rotating machine comprising:
a rotor which is configured to rotate about an axis;
a stator which faces the rotor in a radial direction; and
a plurality of seal fins which are provided so as to be protruded from one of the rotor and the stator toward the other of the rotor and the stator in the radial direction and are arranged with gaps therebetween in an axial direction,
wherein one of the rotor and the stator includes:
an acoustic space which is formed as a hollow portion inside the one of the rotor and the stator; and
a communication hole which allows communication between the acoustic space and a part between adjacent seal fins of the plurality of seal fins, the adjacent seal fins being adjacent to each other in the axial direction.

2. The rotating machine according to claim 1, wherein:
the stator includes a seal ring main body which has a tubular shape centering on the axis, wherein the plurality of seal fins are provided on an inner circumferential surface of the seal ring main body; and
the acoustic space is formed inside the seal ring main body.

3. The rotating machine according to claim 2, wherein a plurality of the acoustic spaces are formed inside the seal ring main body and arranged with gaps therebetween in a circumferential direction.

4. The rotating machine according to claim 3, wherein a volume differs between a pair of acoustic spaces of the plurality of acoustic spaces adjacent to each other in the circumferential direction.

5. The rotating machine according to claim 2, wherein a plurality of the acoustic spaces are formed inside the seal ring main body and arranged with gaps therebetween in the radial direction.

6. The rotating machine according to claim 5, wherein a volume differs between a pair of acoustic spaces of the plurality of acoustic spaces adjacent to each other in the radial direction.

7. The rotating machine according to claim 1, wherein a position in the circumferential direction differs between one end of the communication hole and the other end of the communication hole when viewed in the axial direction.

8. The rotating machine according to claim 1, wherein the communication hole is formed so as to be extended in a direction inclined with respect to the radial direction when viewed in the axial direction.

9. The rotating machine according to claim 1, wherein:
the stator includes:
a stator main body which has a recessed accommodation portion formed on a surface, of the stator main body, which faces the rotor so as to be recessed outward in the radial direction; and
a seal ring which has the plurality of seal fins, wherein at least a part of the seal ring is accommodated in the recessed accommodation portion;
a space in the recessed accommodation portion on a side outward in the radial direction from the seal ring serves as the acoustic space; and
the communication hole is formed in the seal ring so as to penetrate the seal ring, wherein one end of the communication hole communicates with the acoustic space.

10. The rotating machine according to claim 1, wherein:
the rotor includes:
a rotary shaft is formed so as to be extended along the axis; and
a plurality of blades which are provided on an outer circumferential surface of the rotary shaft and are arranged in a circumferential direction;
the stator includes a casing which covers the rotary shaft and the plurality of blades from an outer circumferential side;
the seal fins are provided on a surface, of the casing, which faces the blade in the radial direction; and
the acoustic space is formed inside the casing.

11. The rotating machine according to claim 1, wherein:
the rotor includes:
a rotary shaft is formed so as to be extended along the axis; and
a plurality of blades which are provided on an outer circumferential surface of the rotary shaft and are arranged in a circumferential direction;
the stator includes a casing which covers the rotary shaft and the plurality of blades from an outer circumferential side;
the seal fins are provided on a surface, of the casing, which faces the blade in the radial direction; and
the acoustic space is formed in a box body which is provided on an outer circumferential side of the casing.

12. A seal ring comprising:
a seal ring main body which has a tubular shape centering on an axis;
a plurality of seal fins which are provided on an inner circumferential surface of the seal ring main body so as to be protruded inward in a radial direction and are arranged with gaps therebetween in an axial direction;
an acoustic space which is formed as a hollow portion inside the seal ring main body; and
a communication hole which allows communication between the acoustic space and a part between adjacent seal fins of the plurality of seal fins, the adjacent seal fins being adjacent to each other in the axial direction.

13. The seal ring according to claim 12, wherein a plurality of the acoustic spaces are formed inside the seal ring main body and arranged with gaps therebetween in a circumferential direction.

14. The seal ring according to claim 13, wherein a volume differs between a pair of acoustic spaces of the plurality of acoustic spaces adjacent to each other in the circumferential direction.

15. The seal ring according to claim 12, wherein a plurality of the acoustic spaces are formed inside the seal ring main body and arranged with gaps therebetween in the radial direction.

16. The seal ring according to claim 15, wherein a volume differs between a pair of acoustic spaces of the plurality of acoustic spaces adjacent to each other in the radial direction.

17. The seal ring according to claim 12, wherein a position in the circumferential direction differs between one end of the communication hole and the other end of the communication hole when viewed in the axial direction.

18. The seal ring according to claim 12, wherein the communication hole is formed so as to be extended in a direction inclined with respect to the radial direction when viewed in the axial direction.
